(19) United States
(12) Patent Application Publication
(10) Pub. No.: US 2014/0104844 A1
(43) Pub. Date: Apr. 17, 2014

(54) Customizable Lighting Recessed Module

(71) Applicant: David Fereydouny, Encino, CA (US)

(72) Inventor: David Fereydouny, Encino, CA (US)

(21) Appl. No.: 14/052,198

(22) Filed: Oct. 11, 2013

Related U.S. Application Data
(60) Provisional application No. 61/713,272, filed on Oct. 12, 2012.

(51) Int. Cl. F21V 17/00

(52) U.S. Cl. CPC F21V 17/002
USPC 362/293

(57) ABSTRACT

Some embodiments set forth a customizable lighting module having interchangeable components that adapt the shape, color, and other physical characteristics of the lighting module. The customizable lighting module is comprised primarily of a lighting engine, hood, baffle or reflector, and trim ring. Baffles or reflectors of different colors, reflective finishes, and shapes can be inset within the hood. Similarly, trim rings of different colors, reflective finishes, and shapes can be used to secure the inset baffle or reflector and further customize the physical characteristics of the lighting module.

### CLAIM OF BENEFIT TO RELATED APPLICATIONS

This application claims the benefit of U.S. provisional application 61/713,272, entitled “Customizable Lighting Recessed Module”, filed Oct. 12, 2012. The contents of application 61/713,272 are hereby incorporated by reference.

### TECHNICAL FIELD

The present invention pertains to the field of lighting.

### BACKGROUND

The lighting module is the receptacle that holds and powers a light source. It is a staple found in nearly every home or business with each home or business offering a different environment in which the lighting module is to integrate. Yet with all these different environments, the prior art has not yielded a lighting module that can be customized to its environment. Instead, each lighting module of the prior art provides a static configuration with a static shape and color and wherein the trim ring and baffle or reflector of the lighting module is static. As such, the user searches through different lighting module configurations in order to find the one that integrates with the environment in which it is to be installed. Should the environment change, that particular lighting module cannot be customized in accordance. The lighting module then stands out-of-place as an eye-sore. The lighting module can disrupt the environment. The appropriate resolution may require installing an entirely different lighting module that integrates with the modified environment.

Accordingly, there is a long-felt but previously unaddressed need for a customizable lighting module. Specifically, there is need for a lighting module that can adapt with its environment through interchangeable components.

### BRIEF DESCRIPTION OF THE DRAWINGS

In order to achieve a better understanding of the nature of the present invention a preferred embodiment of the customizable lighting module will now be described, by way of example only, with reference to the accompanying drawings in which:

FIG. 1 illustrates a side exploded view and combined view of the customizable lighting module in accordance with some embodiments.

FIG. 2 provides a front view of the customizable lighting module in accordance with some embodiments.

FIGS. 3-5 illustrate securing the trim ring to the hood using the twist locking mechanism in accordance with some embodiments.

FIGS. 6-9 depict the same customizable lighting module that can be configured with circular components being configured with rectangular components in accordance with some embodiments.

### DETAILED DESCRIPTION OF THE INVENTION

In the following detailed description, numerous details, examples, and embodiments of the customizable lighting module are set forth and described. As one skilled in the art would understand in light of the present description, the customizable lighting module is not limited to the embodiments set forth, and may be practiced without some of the specific details and examples discussed. Also, reference is made to the accompanying figures, which illustrate specific embodiments of the customizable lighting module. It is to be understood that other embodiments can be used and structural changes can be made without departing from the scope of the embodiments herein described.

Some embodiments set forth a customizable lighting module having interchangeable components that adapt the shape, color, and other physical characteristics of the lighting module. The components can be interchanged at any time pre and post installation to allow the user to continually reconfigure and adapt the lighting module as the user's preferences change or the environment for the lighting module changes without having to change the lighting module itself. To enable such customizations, some embodiments provide at least “mix-and-match” or interchangeable baffles or reflectors inserts and trim rings. To further enable such customizations, some embodiments provide a “hot swap” assembly mechanism that retains the integrity and “one-piece” look of the lighting module while allowing for quick, simple, and cost-effective configuration customizations to the lighting module.

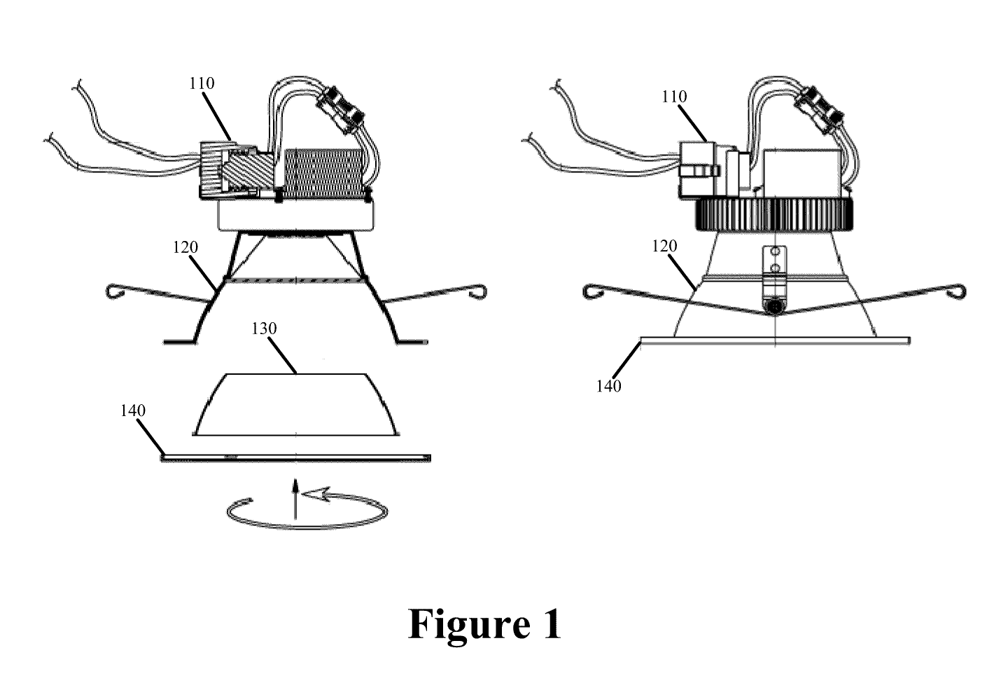

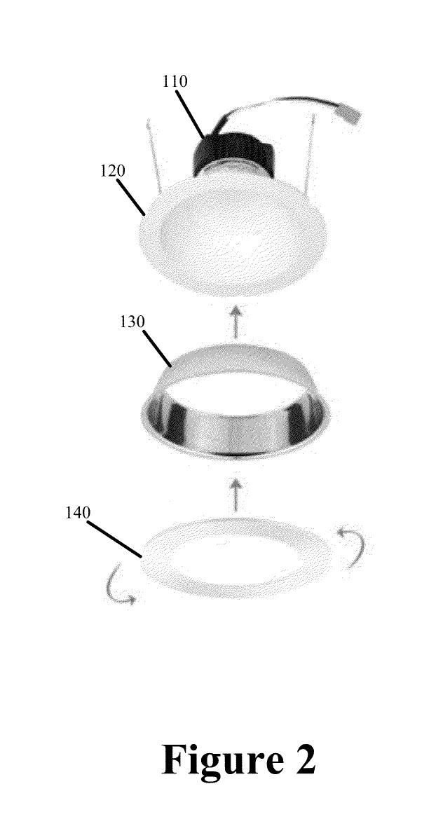

FIG. 1 illustrates a side exploded view and combined view of the customizable lighting module in accordance with some embodiments. FIG. 2 provides a front view of the customizable lighting module in accordance with some embodiments. The depicted implementation is for a recessed application and for use with a light emitting diode (LED) as the light source. However, it should be noted that the customizable lighting module is generally applicable for other applications, light sources, lighting technologies, lighting sockets, and form factors and should therefore not be restricted only to the depicted implementation.

As shown, the customizable lighting module is comprised primarily of a lighting engine 110, hood 120, baffle or reflector 130, and trim ring 140. Each of the baffle or reflector 130 and trim ring 140 is offered in a plurality of different colors, a plurality of reflective finishes varying the amount of reflectivity (e.g., matte to highly reflective), and a plurality of different shapes. By mixing and matching these components, different users can use the same customizable lighting module to produce different configurations that integrate with the different users' preferences and environments. Stated differently, by mixing and matching the components, users can customize the physical characteristics of the lighting module and modify the physical characteristics at any time. The trim ring 140 also provides a novel assembly mechanism that enables the quick and simple interchangeability of the lighting module. Thus, the customizable lighting module provides a single unit that can be customized to suit the preferences of the customer on a component-by-component basis rather than on complete unit-by-unit basis as provided by the prior art.

The lighting engine 110 is located at the base of the customizable lighting module. The lighting engine 110 provides the socket for the light source (e.g., bulb, LED, etc.) of the lighting module. The lighting engine 110 also provides the electrical interface that feeds power from a power source to the light source in order to illuminate the light source. The electrical interface differs according to the light source or the desired electrical output of the lighting module. For instance, when the lighting module is for an LED application, the lighting module includes a 120 volt dimmable LED driver that draws 12 watts when turned on. In some embodiments, the lighting engine 110 further provides a thermal interface. The thermal interface comprises one or more cooling elements, such as a heat sink, that draw excess heat out and away from the interior of the lighting module.

The hood 120 provides the outer covering or housing for the customizable lighting module. The proximal end of the hood 120 extends from the lighting engine 110 to a distal end with the extension being up to several inches in length. As shown in FIG. 1, the hood 120 extends conically away from the base of the lighting engine 110. In some other embodiments, the hood 120 extends cylindrically or rectangularly from the base of the lighting engine 110. The distal end of the hood 120 comprises one end of a male-female coupler with the corresponding end being located on the trim ring 140. The male-female coupler allows for the interchanging of baffles, reflectors, and trim rings as will be discussed below.

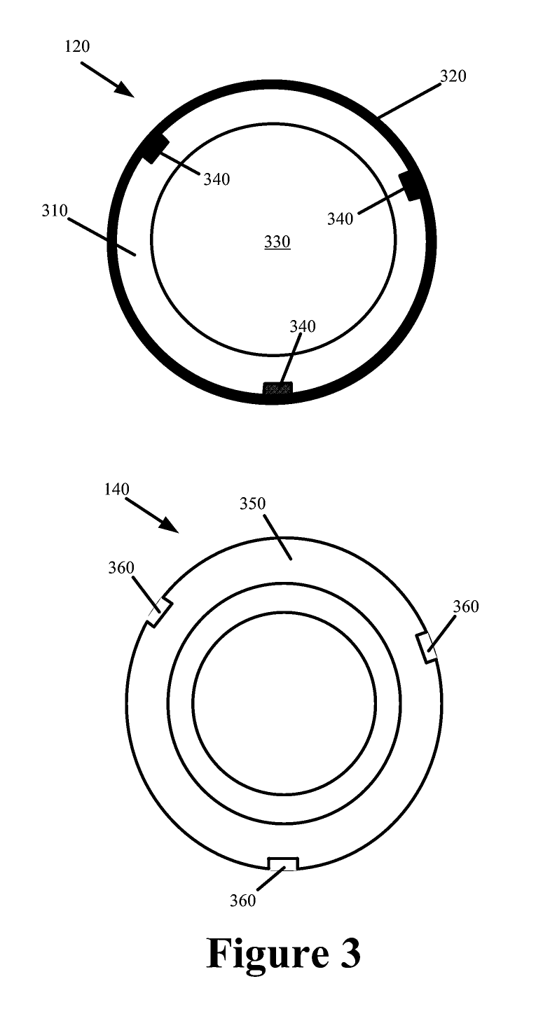

In some embodiments, the hood 120 is itself interchangeable. In some such embodiments, the hood 120 provides a third customization to physical characteristics of the customizable lighting module. For instance, the hood 120 can be changed from a cylindrical casing to any of a rectangular, conical, square, or other regular or irregular shaped casing depending on the desired application. The interchangeability of the hood 120 is desirable when the customizable lighting module for non-recessed applications whereby the exterior casing of the lighting module is visible. In some such embodiments, each hood 120 is offered in any of a plurality of colors, plurality of reflective finishes, and plurality of shapes. To provide for the interchangeability of the hood 120, some embodiments employ a second male-female coupler. One end of the second male-female coupler is located at the proximal end of the hood 120 that attaches to the corresponding second end of the second male-female coupler at the base of the lighting engine 110. One male-female coupling mechanism that can be used to secure the interchangeable hoods is described with reference to FIG. 3-5 below.

The hood 120 may be composed of one or more rigid materials (e.g., plastics or metals). For recessed applications of the customizable lighting module, torsion springs are provided alongside the hood 120 for convenient mounting of the entire customizable lighting module to existing, remodel, or new construction housings.

Customized configuration of the customizable lighting module is also facilitated by the interchangeable baffle or reflector 130 inserts of some embodiments. The baffle differs from a reflector in that the baffle has a ridged reflective surface, whereas the reflector has a smooth reflective surface. The interchangeable baffle or reflector 130 inserts are provided in order to customize the interior physical characteristics of the customizable lighting module. The inserts come in a plurality of different colors (e.g., green, red, yellow, blue, etc.), a plurality of different reflective finishes (ranging from completely matte to highly reflective), and a plurality of different shapes (e.g., cylindrical, rectangular, conical, and other regular and irregular shapes) in some embodiments.

Each different colored baffle or reflector 130, each of the different reflective finishes for the baffle or reflector 130, each different shape of the baffle or reflector 130, and each combination thereof results in a first customization for the customizable lighting module that changes the physical characteristics of the lighting module. In some embodiments, each different colored baffle or reflector 130 also enables a second customization for altering the color output of the lighting module. For example, a red colored baffle that is inset within the customizable lighting module may result in an altered color output than when a blue colored baffle is inset within the customizable lighting module. Similarly, each different reflective finish enables a second customization for altering qualities of the light output, such as the tone and warmth of the light. In some such embodiments, the reflective surface of the baffle or reflector 130 is chosen to absorb various spectrums of light such that the color output, tone, etc. is altered to some degree. Finally, each different shaped baffle or reflector 130 also provides a second customization that configures the lighting module for different environments or applications.

To modify these and other physical characteristics, the user selects a desired baffle or reflector 130 color, finish, and shape configuration and inserts the selected baffle or reflector 130 within the hood 120. This is unlike the prior art whereby the baffle or reflector is fixed to the hood and cannot be changed or customized. Each baffle or reflector 130 has a slightly shorter length and a slightly smaller diameter than the hood 120 in order to fit underneath and shroud the interior of the hood 120.

The trim ring 140 serves a dual purpose within the customizable lighting module. First, the trim ring 140 secures the baffle or reflector 130 within the hood 120 by coupling to the complimentary end of the male-female coupler found on the distal end of the hood 120. In this manner, the many configurable components of the lighting module are locked in place, providing the “one-piece” appearance of the customizable lighting module. Second, the trim ring 140 provides yet another customization for the physical characteristics of the lighting module. Specifically, the trim ring 140 is used to customize the exterior physical characteristic.

In some embodiments, the male-female coupler formed by the trim ring 140 and the distal end of the hood 120 is a twist locking mechanism. FIGS. 3-5 illustrate securing the trim ring 140 to the hood 120 using the twist locking mechanism in accordance with some embodiments.

FIG. 3 illustrates the trim ring 140 from a top view and the hood 120 from a front view in accordance with some embodiments. As illustrated, the trim ring 140 comprises a circular ring 310 with a circumferential lip 320 and a central opening 330. The lip 320 slightly elevates a set of pegs 340 over the circular ring 310. The front view of the hood 120 illustrate its outward facing plate 350 at its distal end. A set of notches 360 are located along the outward facing plate 350 of the hood 120. The set of notches 360 are aligned and complimentary to the pegs 340.

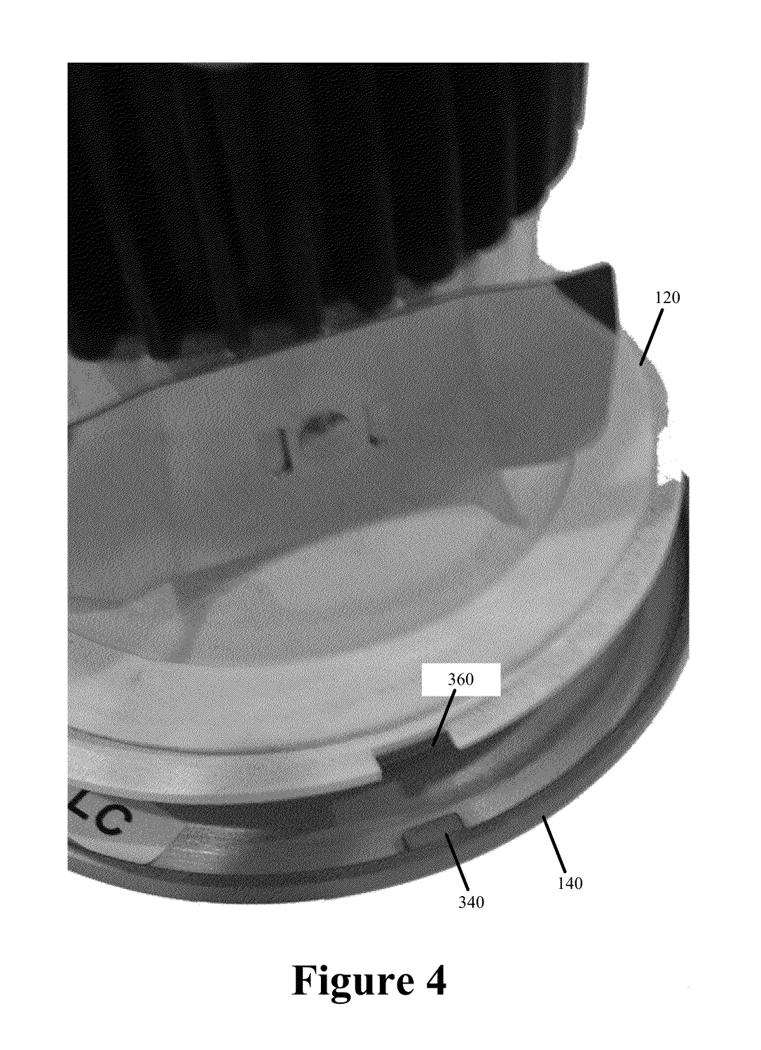

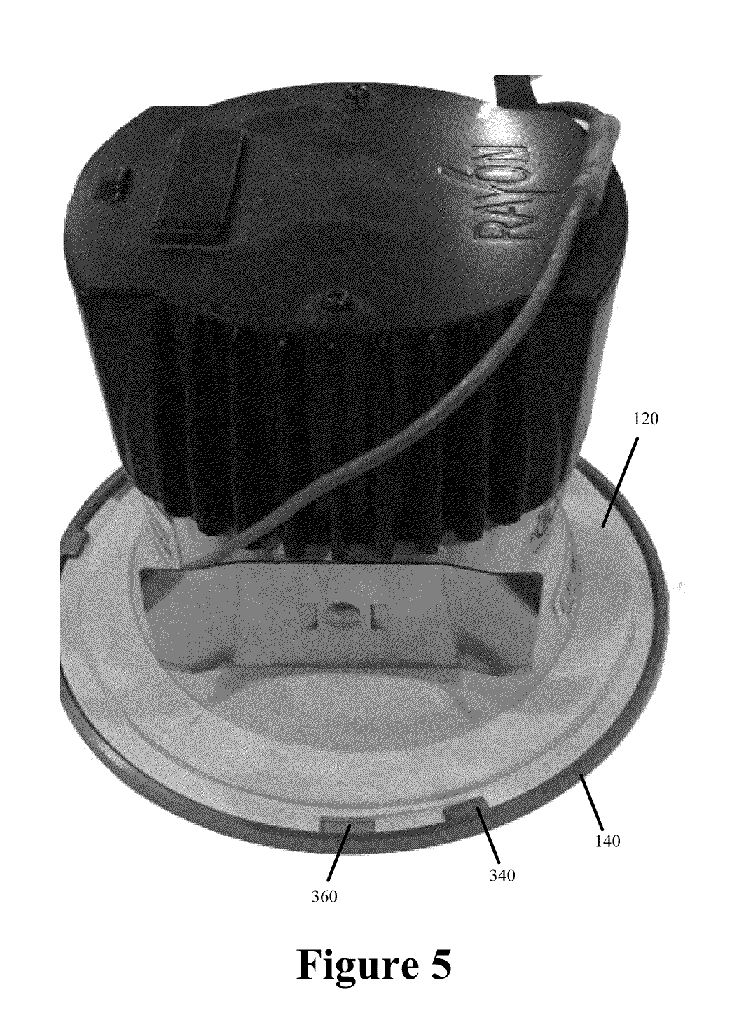

FIG. 4 illustrates aligning the pegs 340 of the trim ring 140 with the notches 360 on the outward facing plate 350 of the hood 120. Once aligned, the trim ring 140 can be pushed towards the hood 120 such that the pegs 340 pass through the notches 360. Once the pegs 340 pass the notches 360, the trim ring 140 can be secured to the hood 120 by turning the trim ring 140, thereby moving the pegs 340 past the notches 360 and over the outward facing plate 350 as shown in FIG. 5.

Once the trim ring 140 is secured to the distal end of the hood 120, the trim ring 140 acts to hold the baffle or reflector 130 that was inset into the hood 120 in place. To replace the baffle or reflector 130, one simply decouples the trim ring 140 from the distal end of the hood 120, removes the trim ring 140, and substitutes the inserted baffle or reflector 130 with another. Using the twist locking mechanism depicted in FIG. 3-5, decoupling the trim ring 140 involves simply twisting the trim ring 140 such that the pegs 340 are again aligned with the notches 360 on the hood 120 faceplate. Thereafter, the trim ring 140 can be pulled away, exposing the interior of the hood 120 and allowing the baffle or reflector 130 to be interchanged.

It should be apparent that other coupling mechanism can also be used to secure the trim ring 140 to the hood 120. For example, the trim ring 140 may have threads that screw into groves found along the distal end of the hood 120 or vice versa.

The trim ring 140 itself is customizable and interchangeable. As with the baffle or reflector 130, the trim ring 140 can be used to customize the color, reflective finish, and shape of the exterior characteristic so as to adapt the customizable lighting module for many different environments. Accordingly, trim ring 140 is provided in a plurality of different configurations, each of which can be secured to the customizable lighting module to provide a second customization of the lighting module. The trim ring 140 comes in a plurality of different colors, a plurality of different reflective finishes, a plurality of different shapes, and different combinations thereof.

In some embodiments, the trim ring 140 contains a lens. The lens allows light to illuminate through the lighting module while covering the aperture through which the light illuminates. The trim ring 140 can be plastic or metallic with the lens being an impact resistant diffused polycarbonate.

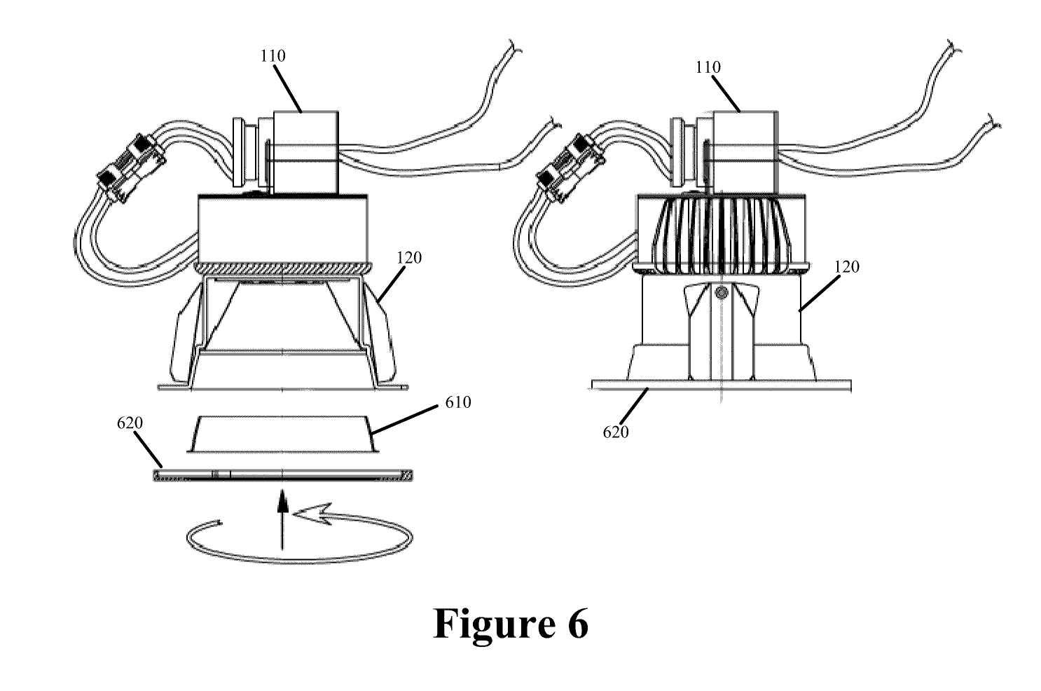

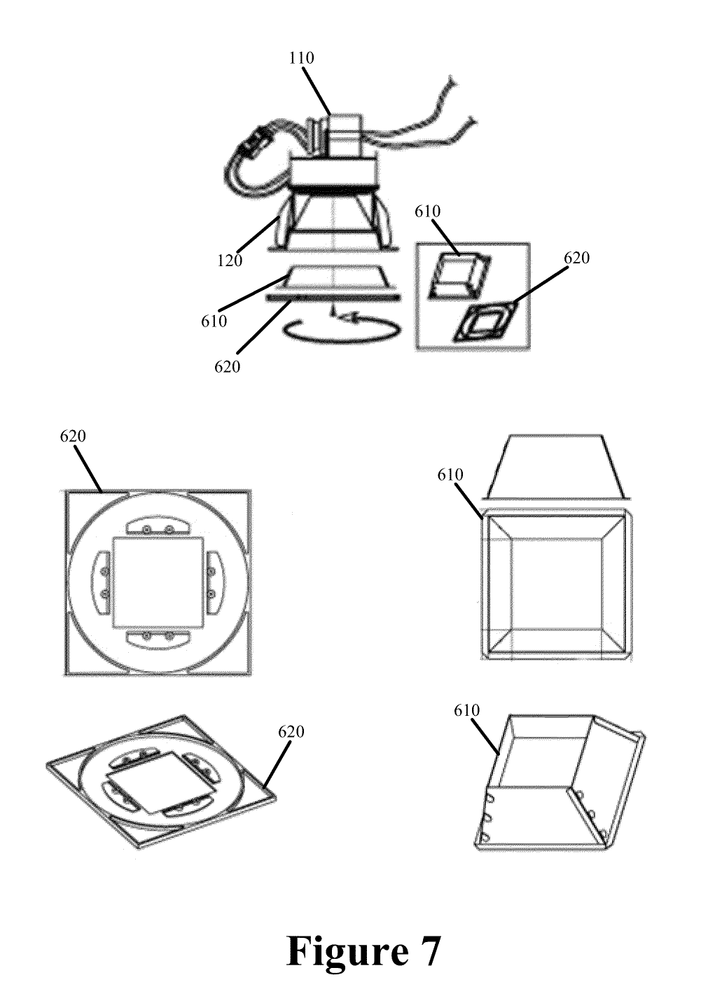

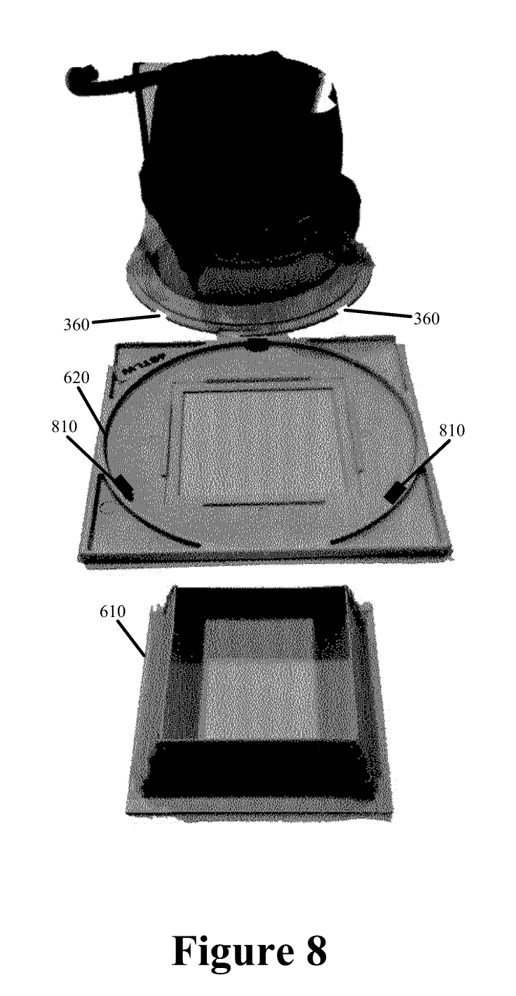

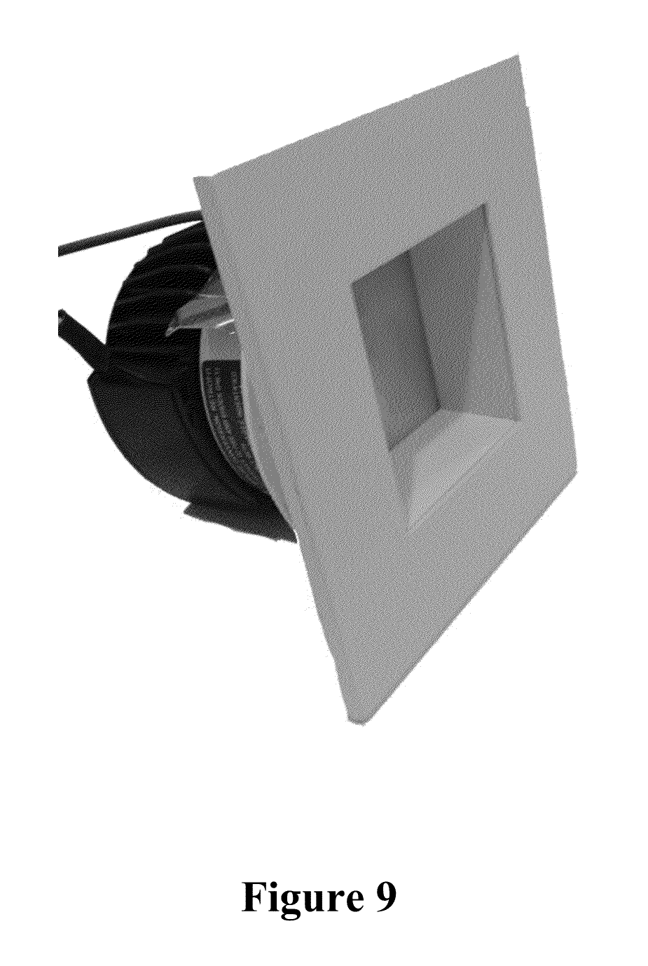

The figures have thusfar depicted the customizable lighting module with circular components. FIGS. 6-9 depict the same customizable lighting module that was earlier configured with circular components now configured with rectangular components in accordance with some embodiments. As shown in these figures, the customizable lighting module is configured with a rectangular baffle or reflector 610 and a rectangular trim ring 620. FIG. 6 illustrates an exploded and combined view of the customizable lighting module that is configured with rectangular components in accordance with some embodiments. FIG. 7 illustrates front and perspective views of the rectangular shaped baffle or reflector 610 and trim ring 620 in accordance with some embodiments. FIG. 8 provides additional perspective views of the rectangular components 610 and 620 in accordance with some embodiments. As can be seen from FIG. 8, the same twist locking mechanism that was used to secure the circular shaped components to the customizable lighting module can also be used to secure the rectangular shaped components to the same customizable lighting module. Specifically, the rectangular shaped baffle or reflector 130 contains a set of pegs 810 that align with the notches 360 on the distal end of the hood 120. FIG. 9 provides a side view of a rectangular shaped trim ring secured to the customizable lighting module in accordance with some embodiments.

I claim:

1. A customizable lighting module comprising:
a lighting engine providing power for illuminating a light source;
a hood comprising a covering extending from a proximal end to a distal end, wherein the proximal end of the hood is coupled to the lighting engine, and wherein the distal end comprises a first coupler of a male-female coupling mechanism;
a plurality of inserts, each insert of the plurality of inserts comprising at least one of a different color, reflective finish, and shape that is adapted for insertion within the hood;
a trim ring comprising a second coupler that couples to the first coupler of the male-female coupling mechanism, the trim ring holding a particular insert from the plurality of inserts within the hood when attached to the hood by coupling the second coupler to the first coupler.

2. The customizable lighting module of claim 1 further comprising a plurality of trim rings, each trim ring of the plurality of trim rings comprising at least one of a different color, reflective finish, and shape, and wherein the trim ring is a particular trim ring selected from the plurality of trim rings.

3. The customizable lighting module of claim 1, wherein the second coupler of the trim ring comprises a set of pegs elevated over a plane of the trim ring and wherein the first coupler comprises a set of notches located along the distal end of the hood.

4. The customizable lighting module of claim 3, wherein coupling the second coupler to the first coupler comprises inserting the set of pegs through the set of notches and twisting the trim ring to reposition the set of pegs over the distal end of the hood.

5. The customizable lighting module of claim 1, wherein the particular insert is a first color and the trim ring is a different second color selected from a plurality of different colored trim rings.

6. The customizable lighting module of claim 1, wherein the particular insert has a first shape and the trim ring is detached from the hood to reconfigure the customizable lighting module with a different insert from the plurality of inserts having a second shape that is different than the first shape.

7. The customizable lighting module of claim 1, wherein the trim ring is a first trim ring of a first shape and the customizable lighting module further comprises a second trim ring of a second different shape that couples to the first coupler of the male-female coupling mechanism.

8. The customizable lighting module of claim 7, wherein the first shape is circular and the second shape is rectangular.

9. The customizable lighting module of claim 1, wherein the trim ring is a first trim ring of a first color and the customizable lighting module further comprises a second trim ring of a second different color that couples to the first coupler of the male-female coupling mechanism.

10. The customizable lighting module of claim 1, wherein the male-female coupler comprises at least one of a twist locking mechanism and a screw coupling mechanism.

11. The customizable lighting module of claim 1, wherein the light source outputs light of a first color, wherein the particular insert is a second color, and wherein color output of the lighting module is a third color that is a combination of the first color and the second color.

12. A reconfigurable lighting module comprising:
a base with a socket;
a hood extending from a proximal end at the base circumferentially around and in the direction of the socket to a distal end, wherein the distal end comprises one end of a two-end coupling mechanism;
a plurality of interchangeable inserts, each insert comprising a reflective surface of at least one of a different color, different reflective finish, and different shape;
a plurality of trim rings, each trim ring of the plurality of trim rings comprising (i) an outward face of at least one of a different color, different reflective finish, and different shape and (ii) a second end of the two-end coupling mechanism, wherein a selected trim ring of a first color holds a selected insert of a second color within the hood by securing the second end of the two-end coupling mechanism of the selected trim ring to the first end of the two-end coupling mechanism of the hood.

13. The reconfigurable lighting module of claim 12, wherein the selected trim ring has a first shape and the selected trim ring is detached from the hood to reconfigure the reconfigurable lighting module with a different trim ring from the plurality of trim rings having a second shape that is different than the first shape.

14. The reconfigurable lighting module of claim 12, wherein the first color of the selected trim ring is visible when the lighting module is powered off and the second color of the selected insert is visible when the lighting module is powered on.

15. The reconfigurable lighting module of claim 12, wherein the second end of the two-end coupling mechanism comprises a set of pegs elevated behind the outward face and wherein the first end of the two-end coupling mechanism comprises a set of notches located along the distal end of the hood.

16. The reconfigurable lighting module of claim 12, wherein the plurality of interchangeable inserts comprise a plurality of baffles and reflectors.

17. The reconfigurable lighting module of claim 12, wherein each insert of the plurality of interchangeable inserts is configured to slide within the hood to modify an interior characteristic of the lighting module by modifying at least one of the interior color, reflective finish, and shape of the reconfigurable lighting module.

18. The reconfigurable lighting module of claim 12, wherein the first end of the two-end coupling mechanism comprises a set of grooves and the second end of the two-end coupling mechanism comprises a set of threads that screw into the set of grooves of the first end.

19. The reconfigurable lighting module of claim 12, wherein the second end of the two-end coupling mechanism comprises a set of grooves and the first end of the two-end coupling mechanism comprises a set of threads that screw into the set of grooves of the second end.

20. A method for customizing a lighting module comprising at least a lighting engine and a hood, the method comprising:
providing a plurality of inserts, each insert of the plurality of inserts comprising at least one of a different color, reflective finish, and shape;
providing a plurality of trim rings, each trim ring of the plurality of trim rings comprising at least one of a different color, reflective finish, and shape;
selecting an internal configuration for the lighting module by selecting a particular insert from the plurality of inserts;
inserting the particular insert within the hood;
selecting an external configuration for the lighting module by selecting a particular trim ring from the plurality of trim rings; and
establishing a user selected configuration for the lighting module by securing the particular insert within the hood by using the particular trim ring to couple to the hood.
